(19) United States
(12) Patent Application Publication
(10) Pub. No.: US 2004/0139339 A1
(43) Pub. Date: Jul. 15, 2004

(54) Data encryption and decryption method and apparatus

(75) Inventors: Ming-Fong Yeh, Taipei (TW); Chin-Mei Lin, Taipei (TW); Chun-Wei Fang, Taipei (TW)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 10/720,214

(22) Filed: Nov. 25, 2003

(30) Foreign Application Priority Data
Nov. 26, 2002 (CN) 02152606.0

(51) Int. Cl. G06F 12/14

(52) U.S. Cl. 713/193

(57) ABSTRACT

The present invention provides a data encryption method and apparatus, in which an encryption algorithm module combination is selected from among a plurality of encryption algorithm module combinations predetermined by the user in cooperation with data attribute matching and a dynamic selection mechanism to perform encryption processing of data. The encryption of data through such alternate use of different encryption algorithm module combinations not only enhances the complexity in decryption of the data, the processing speed is not sacrificed due to use of relatively complicated encryption algorithms to ensure security. Furthermore, in the data decryption method and apparatus according to the present invention, data is decrypted using decryption algorithm module combinations that are dynamically switched according to decryption information appended to the ciphertext.

### BACKGROUND OF THE INVENTION

1. Technical Field

The present invention relates to data encryption and decryption method and apparatus in which encryption and decryption of data are integrated with data attribute matching and alternate use of different encryption algorithm module combinations via a dynamic selection mechanism in the encryption of data so as to provide sufficient data security and protection while ensuring the speed of processing.

2. Related Art

With the popularity of the Internet, many companies are using the Internet to communicate with subsidiaries in different locations. In order to protect confidential data from being stolen and changed by hackers during network transmission of the data, the data are encrypted using an encryption algorithm in conjunction with a key so as to prevent unauthorized access to the data and to ensure the confidentiality of the transmitted data. Hash functions are also used to authenticate the data to ensure that the integrity of the data. There are currently available many products, such as the CISCO's Router, which utilizes the technique of Security Architecture for the IP of RFC2401 to protect data during network transmission.

In an encryption algorithm, the data are converted to a form incomprehensible to human beings. The party receiving the data has to decrypt the data before he/she is able to read the same. Even if the ciphertext are intercepted during the course of transmission, if the intercepting party don't have the key to decrypt the data, the data will be simply garbage. Commonly used encryption algorithms include DES, RSA, 3DES, FEAL, IDEA, etc.

An authentication algorithm converts data to a value of a fixed length, and it is not possible to obtain the original data from this value by a reverse algorithm. Authentication algorithms are mainly used to confirm identities of the sender and receiver, and to inspect the integrity of the data per se. For instance, transmitting the data per se to a hash function for processing can result in a checksum, which is transmitted together with the data. The receiver can inspect the data per se using the checksum to see if they have been changed. Common authentication algorithms include N-HASH, MD5, SHA1, MD4, MD2, etc.

Packets are a kind of data format. Data that are to be transmitted or received via networks are all converted into the form of packets. Prior to data transmission, the data are divided into packets, which are recombined to form the original data upon data reception. If any error occurs during transmission of the packets, the receiver may request retransmission of those packets that have errors so as to effectively save the whole transmission time. Even if the packets are stolen, so long as not all of the packets are stolen, the original complete data will still not be accessible.

The router by CISCO employs the “IP Security Protocol” technique to ensure security of data during network transmission. FIGS. 5 and 6 are block diagrams illustrating data encrypting and decrypting processing devices employed therein. As shown in FIG. 5, 50 denotes a data input portion for input of plaintext. 51 denotes an encryption portion that performs packet encryption processing according to an encryption algorithm decided by the user. 52 denotes an authentication portion that performs packet authentication processing according to an authentication algorithm decided by the user. 53 denotes a data output portion for outputting the ciphertext to a memory or other storage devices. In FIG. 6, 60 denotes a data input portion for inputting ciphertext. 61 denotes an authentication portion for performing packet authentication processing according to the authentication algorithm decided by the user. 62 denotes a decryption portion for performing packet decryption processing according to a decryption algorithm decided by the user. 63 denotes a data output portion for outputting plaintext to a memory or other storage devices.

At the data encrypting device end, plaintext is inputted via the data input portion 50. Then, in the encryption portion 51, encryption of data is performed according to the previously decided encryption algorithm and a key. Next, in the authentication portion 52, authentication of data is performed according to the previously decided authentication algorithm. Finally, the ciphertext is outputted for use via the data output portion 53.

At the data decrypting device end, the ciphertext is inputted via the data input portion 60. Subsequently, in the authentication portion 61, authentication of data is performed according to the previously decided authentication algorithm. Then, in the decryption portion 62, decryption of data is performed according to the previously decided decryption algorithm and key. Finally, plaintext is sent to the data output portion 63 for use.

In the above-described processing devices for securing Internet data communication transmission and reception, encryption and authentication algorithms are used to provide the data integrity and data confidentiality services. Hence, if a 3DES algorithm is used to encrypt data and if a SHA1 algorithm is used to authenticate the data, the processing speed will be reduced. However, if, for purposes of increasing the speed, a DES algorithm is used to. encrypt the data and an MD5 algorithm is used to authenticate the data, the security level of data confidentiality and data integrity will be reduced drastically. Therefore, how to find the balance between security level and processing speed is an important topic in the industry.

### SUMMARY OF THE INVENTION

To overcome the aforesaid problems, a data encryption method according to one aspect of the present invention includes the following steps:

Step A: constructing a security class database for storing a plurality of entries of records of data, each of the entries of records including a data attribute description field and a corresponding encryption definition field, the encryption definition field including a plurality of encryption algorithm module indicators;

Step B: inputting digital data to be encrypted;

Step C: from the security class database, finding a data attribute description that matches attribute of the digital data, and retrieving the corresponding encryption definition data;

Step D: from the retrieved encryption definition data, selecting at random an encryption algorithm module indicator;

Step E: with the selected encryption algorithm module indicator as a guide, controlling encryption processing of the inputted digital data; and

Step F: appending decryption information to the digital data that has undergone encryption processing for subsequent output.

A data encryption method according to another aspect of the present invention comprises the following steps:

Step A: constructing an encryption module database for storing a plurality of entries of records of data, each of the entries of records containing an encryption algorithm module indicator and an authentication algorithm module indicator;

Step B: constructing a security class database for storing a plurality of entries of records of data, each of the entries of records containing a data attribute description field and a corresponding encryption definition field, the encryption definition field including a plurality of encryption module database indexes;

Step C: inputting digital data to be encrypted;

Step D: from the security class database, finding a data attribute description that matches attribute of the digital data, and retrieving the corresponding encryption definition data;

Step E: from the retrieved encryption definition data, selecting at random an encryption module database index;

Step F: according to the retrieved encryption module database index, selecting an entry of record from the encryption module database;

Step G: with the selected entry of record as a guide, controlling encryption processing, including the type of encryption and the type of authentication, of the inputted digital data; and

Step H: appending decryption information to the digital data that has undergone encryption processing for subsequent output.

A data encryption method according to a further aspect of the present invention comprises the following steps:

Step A: constructing encryption definition data containing a plurality of encryption algorithm module indicators;

Step B: inputting digital data to be encrypted;

Step C: from the encryption definition data, selecting at random an encryption algorithm module indicator;

Step D: with the selected encryption algorithm module indicator as a guide, controlling encryption processing of the inputted digital data; and

Step E: appending decryption information to the digital data that has undergone encryption processing for subsequent output.

A data encryption method according to still another aspect of the present invention comprises the following steps:

Step A: constructing an encryption module database for storing a plurality of entries of records of data, each of the entries of records containing an encryption algorithm module indicator and an authentication algorithm module indicator;

Step B: constructing encryption definition data which includes a plurality of encryption module database indexes;

Step C: inputting digital data to be encrypted;

Step D: from the encryption definition data, selecting at random an encryption module database index;

Step E: according to the retrieved encryption module database index, selecting an entry of record from the encryption module database;

Step F: with the selected entry of record as a guide, controlling encryption processing, including the type of encryption and the type of authentication, of the inputted digital data; and

Step G: appending decryption information to the digital data that has undergone encryption for subsequent output.

A data encryption method according to yet another aspect of the present invention comprises the following steps:

Step A: constructing a security class database for storing a plurality of entries of records of data, each of the entries of records containing a data attribute description field and a corresponding encryption definition field, the encryption definition data field being an encryption algorithm module indicator;

Step B: inputting digital data to be encrypted;

Step C: from the security class database, finding a data attribute description that matches attribute of the digital data, and retrieving the encryption algorithm module indicator of the corresponding encryption definition field;

Step D: with the selected encryption algorithm module indicator as a guide, controlling encryption processing of the inputted digital data; and

Step E: appending decryption information to the digital data that has undergone encryption processing for subsequent output.

A data encryption method according to still a further aspect of the present invention comprises the following steps:

Step A: constructing an encryption module database for storing a plurality of entries of records of data, each of the entries of records containing an encryption algorithm module indicator and an authentication algorithm module indicator;

Step B: constructing a security class database for storing a plurality of entries of records of data, each of the entries of records containing a data attribute description field and a corresponding encryption definition field, the encryption definition data field being an encryption module database index;

Step C: inputting digital data to be encrypted;

Step D: from the security class database, finding a data attribute description that matches attribute of the digital data, and retrieving the encryption module database index from the corresponding encryption definition field;

Step E: with the retrieved encryption module database index as a guide, selecting an entry of record from the encryption module database;

Step F: with the selected entry of record as a guide, controlling encryption processing, including the type of encryption and the type of authentication, of the inputted digital data; and

Step G: appending decryption information to the digital data that has undergone encryption processing for subsequent output.

A data encryption apparatus according to one aspect of the present invention has an input portion for input of data and an output portion for output of data after encryption processing thereof, the apparatus further comprising: a security class database for storing a plurality of entries of records of data, each of the entries of records containing a data attribute description field and a corresponding encryption definition field, the encryption definition field including a plurality of encryption algorithm module indicators;

an inspecting portion for inspecting and separating the data inputted via the input portion into parameter data or digital data;

a parameter processing portion for updating the security class database with the parameter data sent from the inspecting portion;

an attribute inspecting portion for finding from the security class database a data attribute description that matches attribute of the digital data sent from the inspecting portion and for transmitting the corresponding encryption definition data to a encryption selecting portion;

the encryption selecting portion, which selects at random an encryption algorithm module indicator from the retrieved encryption definition data; and

an encryption processing portion for controlling encryption processing of the inputted digital data using the encryption algorithm module indicator selected by the encryption selecting portion as a guide.

A data encryption apparatus according to another aspect of the present invention has an input portion for input of data and an output portion for output of data after encryption processing thereof, the apparatus further comprising:

a encryption module database for storing a plurality of entries of records of data, each of the entries of records containing an encryption algorithm module indicator;

an inspecting portion for inspecting and separating the data inputted via the input portion into parameter data or digital data;

a parameter processing portion for updating the encryption module database using the parameter data from the inspecting portion;

a encryption selecting portion for selecting at random an entry of record from the encryption module database; and

an encryption processing portion for controlling encryption processing of the inputted digital data using the entry of record selected by the encryption selecting portion as a guide.

A data encryption apparatus according to a further aspect of the present invention has an input portion for input of data and an output portion for output of data after encryption processing thereof, the apparatus further comprising:

a security class database for storing a plurality of entries of records of data, each of the entries of records containing a data attribute description field and a corresponding encryption definition field, the encryption definition field being an encryption algorithm module indicator;

an inspecting portion for inspecting and separating the data inputted via the input portion into parameter data or digital data;

a parameter processing portion -for updating the security class database with the parameter data from the inspecting portion;

an attribute inspecting portion for finding from the security class database a data attribute description that matches attribute of the digital data sent from the inspecting portion and for transmitting the corresponding encryption definition data to an encryption processing portion; and

the encryption processing portion for controlling encryption processing of the inputted digital data using the encryption algorithm module indicator selected by the attribute inspecting portion as a guide.

A data decryption method according to one aspect of the present invention comprises the following steps:

Step A: inputting digital data to be decrypted;

Step B: inspecting whether the digital data includes a decryption algorithm module indicator and, in the affirmative, retrieving the decryption algorithm module indicator or, in the negative, setting the data to be decrypted as equivalent to inputted data for subsequent processing in step D;

Step C: with the retrieved decryption algorithm module indicator as a guide, controlling decryption processing of the inputted digital data; and

Step D: outputting the digital data that has undergone decryption.

A data decryption method according to another aspect of the present invention comprises the following steps:

Step A: constructing a decryption module database for storing a plurality of entries of records of data, each of the entries of records being a decryption algorithm module indicator;

Step B: inputting digital data to be decrypted;

Step C: inspecting whether the digital data includes a decryption module database index and, in the affirmative, retrieving the decryption module database index or, in the negative, setting the data to be decrypted as equivalent to inputted data for subsequent processing in step F;

Step D: with the retrieved decryption module database index as a guide, selecting an entry of record from the decryption module database;

Step E: with the selected entry of record as a guide, controlling decryption processing of the inputted digital data; and

Step F: outputting the digital data that has undergone decryption.

A data decryption apparatus according to one aspect of the present invention has an input portion for input of data and an output portion for output of data after decryption processing thereof, the apparatus further comprising:.

an inspecting portion for inspecting whether the data inputted via the input portion includes a decryption algorithm module indicator and, in the affirmative, retrieving the decryption algorithm module indicator or, in the negative, transmitting the inputted data directly to the output portion; and

a decryption processing portion for controlling decryption processing of the inputted digital data using the decryption algorithm module indicator retrieved by the inspecting portion as a guide.

According to the construction of the data encryption apparatus of the present invention, the user inputs data via the input portion. The inspecting portion inspects and separates the inputted data into parameter data or data to be encrypted. In the case of parameter data, the same is sent to a parameter processing portion for updatating a security class database or an encryption module database. In the case of data to be encrypted, the same is sent to an attribute inspecting portion. The attribute inspecting portion finds from the security class database a data attribute description that matches the attribute of the inputted data, and retrieves encryption definition data for transmission to a encryption selecting portion. The encryption selecting portion dynamically selects an encryption module database index from the encryption definition data, and retrieves an entry of encryption module combination record from the encryption module database based thereon for transmission to an encryption processing portion. The encryption processing portion controls encryption processing, including the type of encryption and the type of authentication, of the inputted data to be encrypted according to the encryption module combination transmitted thereto by the encryption processing portion. Finally, the same is outputted after an output portion has appended decryption information thereto.

Further, the present invention provides users with a data decryption apparatus. According to the data decryption apparatus of the present invention, the user inputs data via an input portion. An inspecting portion inspects and separates the inputted data into parameter data or digital data to be decrypted. In the case of parameter data, the same is sent to a parameter processing portion for updating a decryption module database. In the case of data to be decrypted, the same is inspected to determine whether there is decryption information. In the affirmative, a decryption module database index is retrieved from the decryption information, and an entry of decryption module combination record is retrieved from the decryption module database based thereon for transmission to a decryption processing portion for processing. Otherwise, the inputted digital data is sent to an output portion for output. The decryption processing portion controls decryption processing, including the type of decryption and the type of authentication, of the inputted data to be decrypted according to the decryption module combination record transmitted thereto. Finally, the data is outputted via an output portion.

### BRIEF DESCRIPTION OF THE DRAWINGS

Other features and advantages of the present invention will become apparent in the following detailed description of the preferred embodiments with reference to the accompanying drawings, of which:

FIG. 1 is a block diagram of the preferred embodiment of a data encryption apparatus according to the present invention;

FIG. 2 is a block diagram of the preferred embodiment of a data decryption apparatus according to the present invention;

FIG. 3 is a process flowchart of the data encryption operation in the preferred embodiment of the data encryption apparatus according to the present invention;

FIG. 4 is a process flowchart of the data decryption operation in the preferred embodiment of the data decryption apparatus according to the present invention;

FIG. 5 is a system block diagram of a data encryption device of the prior art;

FIG. 6 is a system block diagram of the data decryption device of the prior art;

FIG. 7 is a schematic view to illustrate the structure of a security class database in the preferred embodiment of the data encryption apparatus according to the present invention;

FIG. 8 is a table describing possible data attribute description commands of the data attribute description data in the security class database of the preferred embodiment of the data encryption apparatus according to the present invention;

FIG. 9 is a schematic view to illustrate the structure of the encryption definition data in the security class database of the preferred embodiment of the data encryption apparatus according to the present invention;

FIG. 10 is a schematic view to illustrate the structure of an encryption module database of the preferred embodiment of the data encryption apparatus according to the present invention;

FIG. 11 is a schematic view to illustrate the structure of a decryption module database of the preferred embodiment of the data encryption apparatus according to the present invention;

FIG. 12 is a schematic view to illustrate the structure of inputted data in the preferred embodiment of the data encryption apparatus according to the present invention;

FIG. 13 is a schematic view to illustrate the structure of outputted data in the preferred embodiment of the data encryption apparatus according to the present invention;

FIG. 14 is an example to illustrate processing in the preferred embodiment of the data encryption apparatus according to the present invention;

FIG. 15 is an example to illustrate processing in the preferred embodiment of the data decryption apparatus according to the present invention;

FIG. 16 is a block diagram of another preferred embodiment of the data encryption apparatus according to the present invention; and

FIG. 17 is a block diagram of still another preferred embodiment of the data encryption apparatus according to the present invention.

### DETAILED DESCRIPTION OF THE PREFERRED EMBODIMENTS

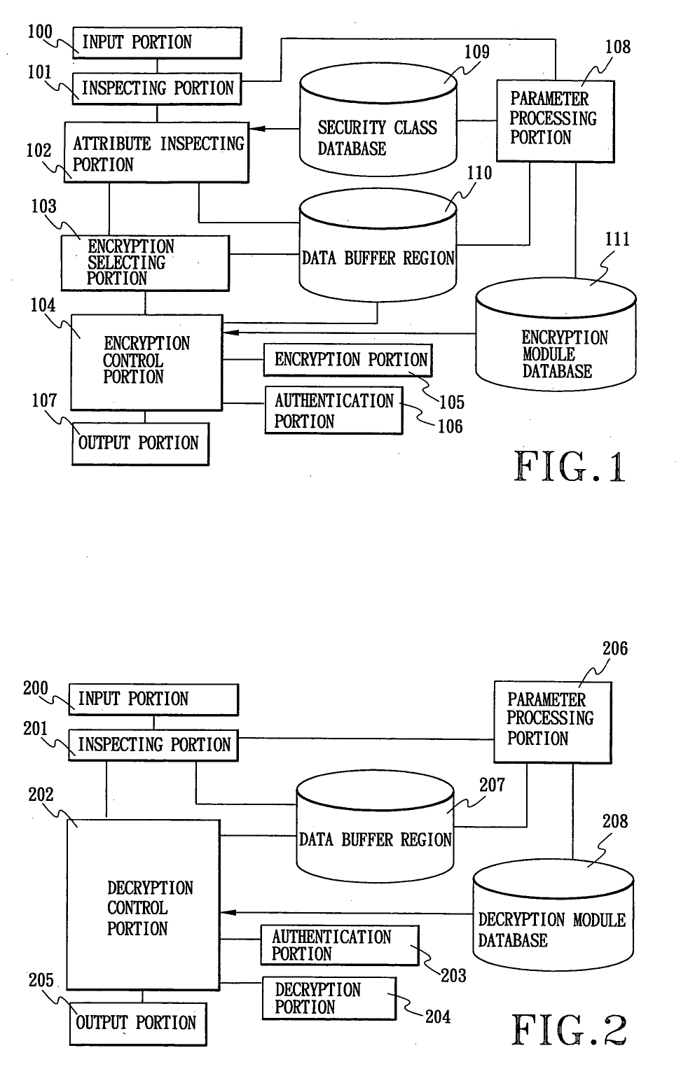

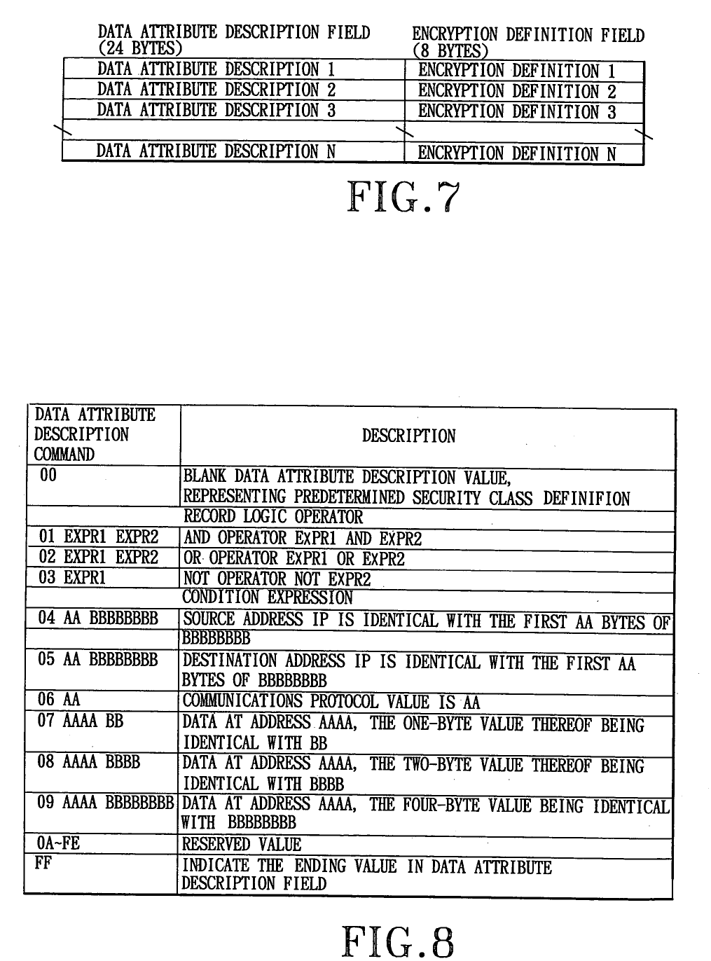

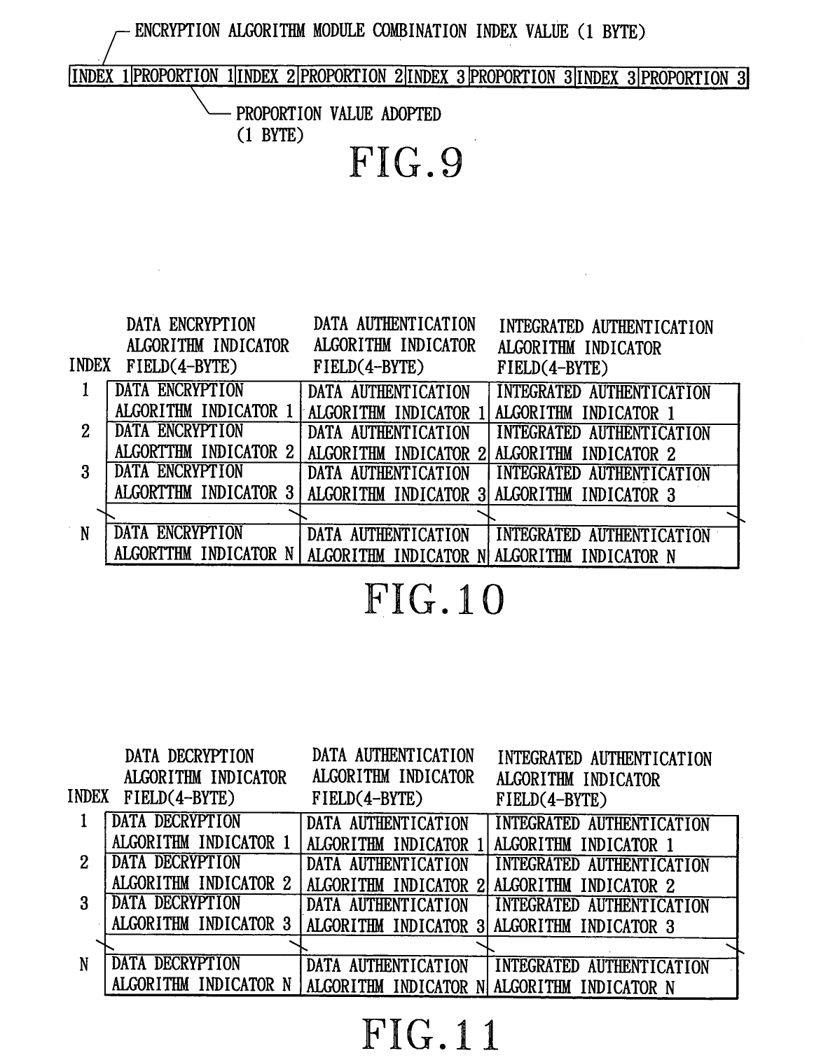

FIG. 1 is a block diagram of a preferred embodiment of a data decryption apparatus according to the present invention. In FIG. 1, 109 denotes a security class database that stores a plurality of entries of records of data. Each entry of record includes a data attribute description and a corresponding encryption definition data. The data attribute description occupies 24 bytes, whereas the encryption definition data occupies 8 bytes. FIG. 7 is a schematic view illustrating the structure thereof. The data attribute description is provided for purposes of comparing attributes of inputted packet data, and is constituted by logic operators and condition expressions. The total length thereof shall not exceed 24 bytes. If it is less than 24 bytes, an ending value FF must be added to the end of the attribute description data as an ending. A description of the commands relating to the data attribute descriptions is illustrated in FIG. 8. The encryption definition data is provided for dynamic selection of encryption algorithm modules, and is constituted by four sets of data. Each set of data includes an encryption algorithm module index which occupies one byte and a proportion value adopted thereby which occupies 1 byte. If the encryption definition data is less than 4 sets, FF must be added to the end thereof. FIG. 9 is a schematic view illustrating the structure thereof.

111 denotes an encryption module database which stores relevant data of various combinations of encryption algorithms, authentication algorithms and integrated authentication algorithms for conducting encryption of inputted data. FIG. 10 is a schematic view showing the structure of the encryption module database. Each combination is represented by one record. Each entry of record includes a data encryption algorithm indicator, a data authentication algorithm indicator, and an integrated authentication algorithm indicator. Each indicator, i.e., the address of the algorithm program, is constituted by four bytes.

The contents of the data encryption algorithm indicator can be:

DES encryption algorithm indicator, or

3DES encryption algorithm indicator, or

RSA encryption algorithm indicator, or

RC4 encryption algorithm indicator, or

FEAL encryption algorithm indicator, or

IDEA encryption algorithm indicator, or

TWOFISH encryption algorithm indicator.

The contents of the data authentication algorithm indicator and the integrated authentication algorithm indicator can be:

MD5 authentication algorithm indicator, or

SHA1 authentication algorithm indicator, or

N-HASH authentication algorithm indicator.

This preferred embodiment is exemplified using seven encryption algorithms and three authentication algorithms, and takes into account situations that do not require encryption or authentication. The encryption module database can store at most (7+1)*(3+1)*(3+1)=128 entries of records.

110 denotes a data buffer region for temporary storage of sequence data generated by a encryption selecting portion, encryption module algorithm-related data stored by a parameter inspecting portion, and temporarily stored data required by a data attribute inspecting portion and an encryption control portion during the course of processing.

100 denotes an input portion which is formed by a keyboard or any input device that permits input of ordinary to-be-encrypted data or parameter data.

101 denotes an inspecting portion for inspecting inputted data which, in the case of parameter data, will be sent to a parameter processing portion for processing or otherwise sent to an attribute inspecting portion for processing.

102 denotes the attribute inspecting portion, which finds from the security class database 109 a data attribute stored in a data attribute description field that matches the attribute of the inputted data, which sends the corresponding encryption definition data to the encryption selecting portion to obtain an index of the encryption module database, and which sends the index together with the inputted data to the encryption control portion for processing..

103 denotes the encryption selecting portion which, according to each of the encryption module database indexes in the encryption definition data and the proportion values adopted thereby, generates in the data buffer region 110 a sequence of the corresponding number of indexes according to the proportion values adopted thereby. A random number generator generates a value and performs a MOD operation using the sum of the proportions adopted by the modules as a denominator to obtain a remainder, which is used as an index to retrieve an encryption module database index from the previously generated sequence. The result and the to-be-encrypted data are then sent to the encryption processing portion.

104 is an encryption control portion which, according to the encryption module database index, obtains a data encryption algorithm indicator, a data authentication algorithm indicator and an integrated authentication algorithm indicator for encryption processing of the inputted data according to the algorithm module indicated by each of the indicators.

105 is an encryption portion which, according to the encryption algorithm indicator and the relevant data required thereby, performs encryption processing of the inputted data and sends the result to the encryption control portion.

106 is an authentication portion which, according to the authentication algorithm indicator and the relevant data required thereby, performs authentication processing of the inputted data and sends the result to the encryption control portion.

107 is an output portion which appends decryption information to the ciphertext and sends the same to a memory device or any other output device.

108 is a parameter processing portion for checking the parameter data inputted via the inspecting portion. If the parameter is an encryption algorithm module parameter, the same is used to update to the encryption algorithm module database. If the parameter is a security class data parameter, the same is used to update to the security class database. In neither case, an error code is transmitted.

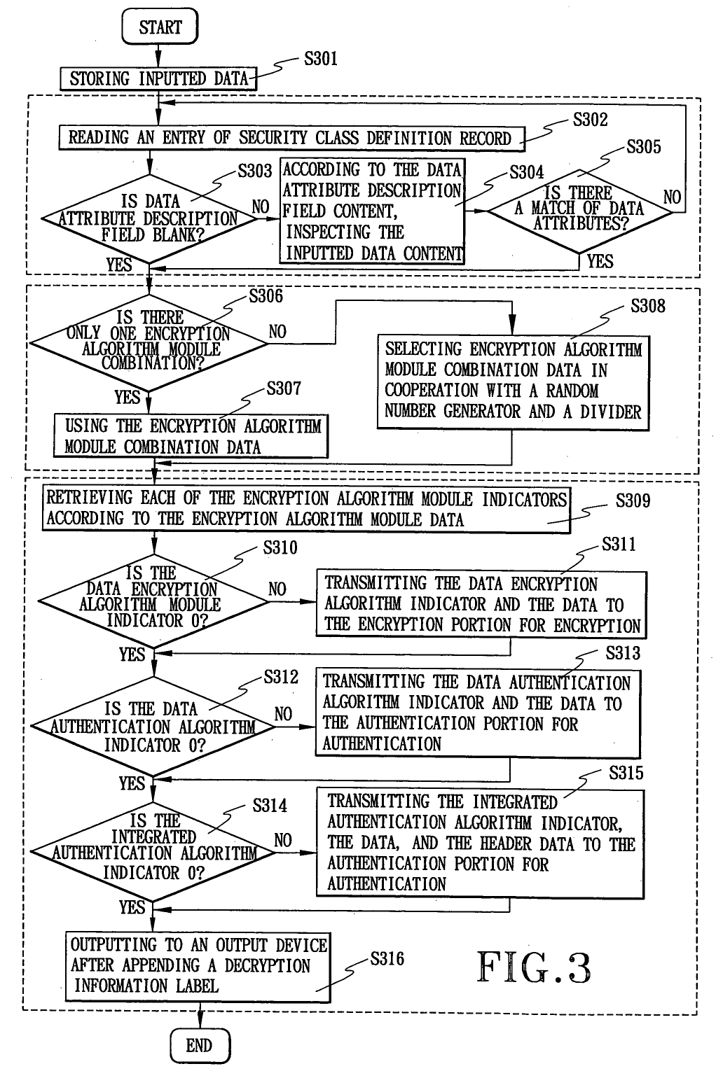

FIG. 3 is a process flowchart of the data encryption operation in the preferred embodiment of the data encryption apparatus according to the present invention. In the block diagram of FIG. 1, when the inspecting portion 101 determines that the inputted data is data to be encrypted, the attribute inspecting portion 102 starts operation. In FIG. 3, the inputted data is stored in step S301. Then, the flow goes to the attribute inspecting portion 102, which finds the encryption definition data to which the attribute of the data corresponds. Firstly, an entry of security definition data is read in step S302. Then, in step S303, it is determined whether the data attribute description field thereof is blank. If yes, this indicates that the same is predetermined security class data, and the flow goes directly to step S306. Otherwise, the contents of the inputted data are inspected according to the data in the data attribute description field. In step S304, it is determined whether there is a match of data attributes. If yes, the flow goes to step S306. Otherwise, the flow returns to step S302. In step S306, the encryption selecting portion 103 starts dynamic selection of the encryption algorithm module combinations. Firstly, in step S306, it is determined whether the encryption definition data contains only one encryption algorithm module combination. If yes, this indicates that dynamic selection is not required to be executed, and the flow goes to step S307 to set that the one module combination that is to be used. Then, the flow goes to step S309. Otherwise, the flow goes to step S308, in which, according to the proportion adopted by each of the modules, a sequence is generated. A random number generator is further used to generate a value, and a MOD operation is performed using the sum of the proportions adopted by the modules as the denominator so as to obtain a remainder. The remainder serves as an index to obtain an encryption algorithm module combination in the previous sequence of data. Subsequently, the flow goes to S309. In step S309, the encryption processing portion 104 starts data encryption processing. Firstly, each of the module indicators is retrieved according to the encryption algorithm module combination data in step S309. Then, in step S310, it is determined whether the data encryption algorithm module indicator is 0. If yes, this indicates that encryption processing is not to be executed, and the flow goes to step S312. Otherwise, the flow goes to step S311, in which the encryption indicator and the parameter required by the indicator, together with the inputted data, are processed and encrypted by the encryption portion 105 to obtain an encryption result. The flow then goes to step S312. In step S312, it is determined whether the data authentication algorithm indicator is 0. If yes, this indicates that authentication processing is not to be executed, and the flow goes to step S314. Otherwise, the flow goes to step S313, in which the authentication indicator and the parameter required thereby, together with the currently processed processing result data, are processed and authenticated by the authentication portion 106 to obtain an authentication result. The flow then goes to step S314. In step S314, it is determined whether the integrated authentication algorithm indicator is 0. If yes, this indicates that integrated authentication processing is not to be executed, and the flow goes to step S316. Otherwise, the flow goes to step S315, in which the authentication indicator and the parameter required by the indicator, together with the currently processed processing result data and the header data are processed and authenticated by the authentication portion 106 to obtain an authentication result. The flow then goes to step S316. In step S316, decryption information is appended to the ciphertext for output to a memory device or any other device.

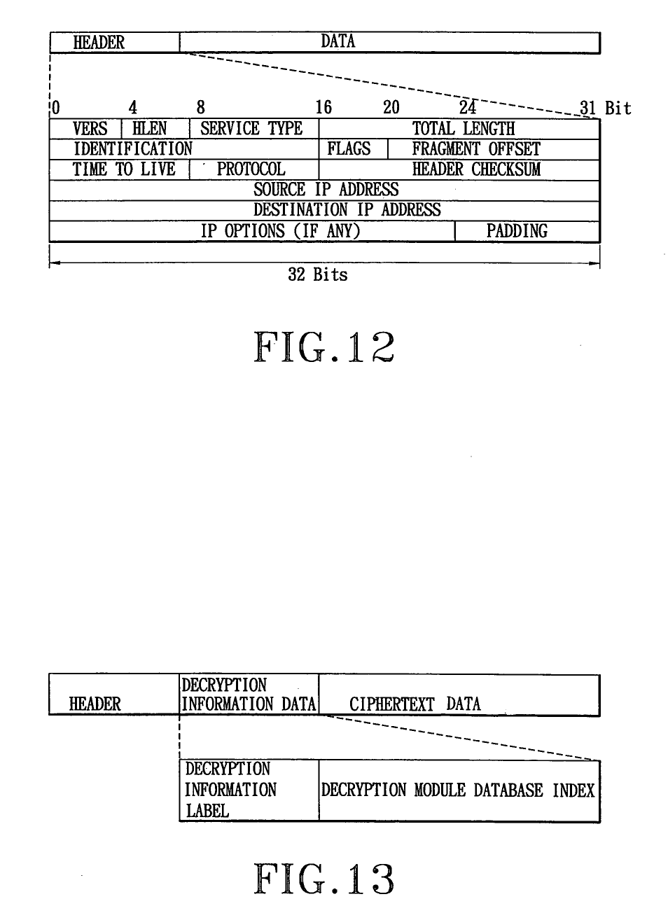

FIG. 12 is a schematic view to illustrate the structure of inputted packet data in the preferred embodiment of the data encryption apparatus according to the present invention. In FIG. 12, the inputted data is an IP packet of Internet communication and includes an IP header and the transmitted data. In the header data, VERS represents the version used by the IP packet, the size thereof being 4 bits. HLEN represents the IP packet header length measured in 32-bit words, the size thereof being 4 bits. SERVICE TYPE represents the form of service of the IP packet, the size thereof being 8 bits. TOTAL LENGTH represents the total length and size of the IP packet, the size thereby being 16 bits. IDENTIFICATION represents identification data of the IP packet, the size thereof being 16 bits. FLAGS represents flag data of the IP packet, the size thereof being 4 bits. FRAGMENT OFFSET represents the displacement address of the data of the IP packet, the size thereof being 12 bits. TIME TO LIVE represents the longest time for Internet transmission of the IP packet, the unit being seconds, and the size thereof being 8 bits. PROTOCOL represents the communications protocol value of the IP packet data field, the size thereof being 8 bits. HEADER CHECKSUM represents checksum data of the header of the IP packet, the size thereof being 16 bits. SOURCE IP ADDRESS represents the source IP address of the IP packet, the size thereof being 32 bits. DESTINATION IP ADDRESS represents the destination IP address of the IP packet, the size thereof being 32 bits. IP OPTIONS represents the additional data of the header of the IP packet, the size thereof being 40 bits at most. PADDING serves to compensate the length of the header of the IP packet to a multiple of 4 bytes.

FIG. 13 is a schematic view to illustrate the structure of outputted data according to the preferred embodiment of a data encryption apparatus of this invention. The outputted data is constituted by an IP header, decryption information data and ciphertext.

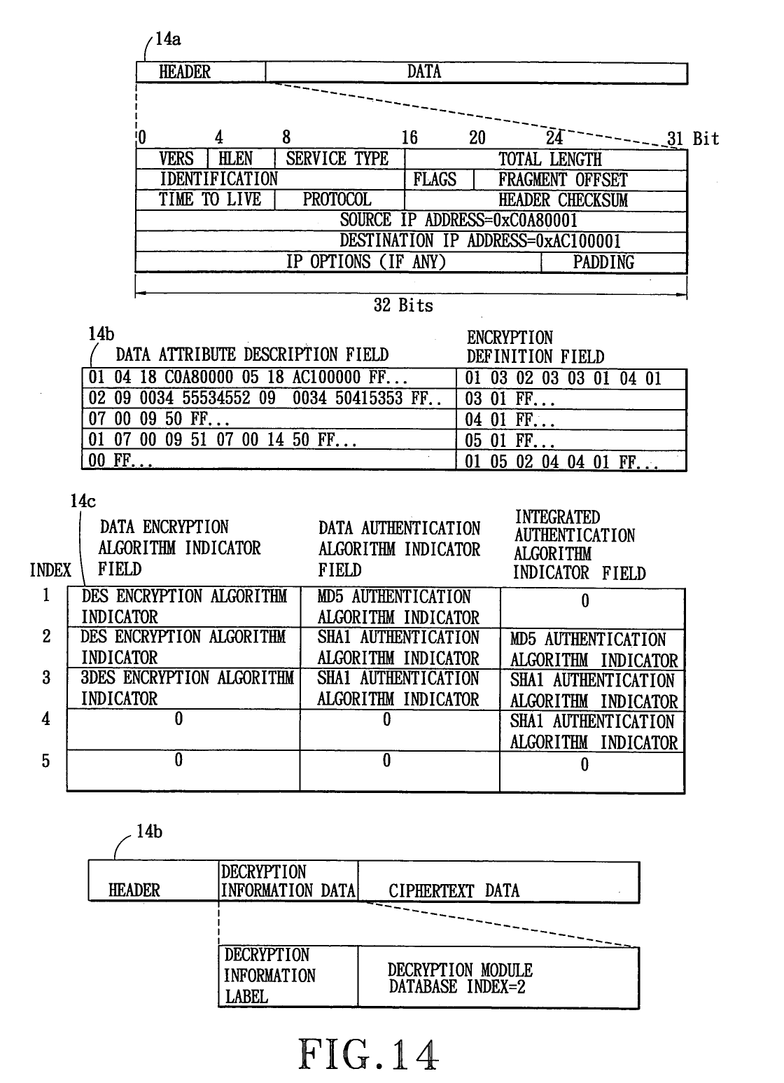

An example of processing according to the preferred embodiment of the data encryption apparatus of the present invention is described hereinafter. FIG. 14 illustrates the exemplary data to be processed by the preferred embodiment of the data encryption apparatus of this invention. In FIG. 14, 14b denotes the data of the security class database at the onset of the, encryption operation flow in this processing example. 14c denotes the data of the encryption module database at the onset of the encryption operation flow in this processing example. 14a denotes inputted data at the start of the encryption operation flow in this processing example. In FIG. 3, after the inputted data (as shown in 14a) is received in step S301, the first entry of data is read from the data in the security class database in step S302. The first fourteen bytes of the data attribute description data are “01 04 18 C0A80000 05 18 AC100000 FF”. The last ten bytes are all “FF”. The encryption definition data is “01 03 02 03 03 01 04 01”. In step S303, it is determined that the data attribute description data is not blank. The flow then goes directly to S304. In step S304, firstly, according to the data attribute description command description table of FIG. 8, the data attribute description data is interpreted such that when the first 24 bit values of both the source IP address in the inputted packet data and C0A80000 are identical and that the first 24 bit values of both the destination IP address and AC100000 are identical, the inputted packet data is deemed to be true. Otherwise, the inputted packet data is deemed to be false. Subsequently, it can be known from the contents of the inputted data (as shown in 14a) that the first 24 bit values of the source IP address and C0A80001 are identical, and that the first 24 bit values of the destination IP address AC100001 and AC100000 are identical. Therefore, a match of the data attributes is set. In step S305, when the result obtained in step S304 is a match of the data attributes, the flow goes directly to step S306. In step S306, the encryption definition data is inspected to determine if there is only one entry of data. Since the data is 01 03 02 03 03 01 04 01, there is not only one single entry of encryption algorithm module combination. Therefore, the flow goes to step S308. In step S308, according to the encryption module database index in the current encryption definition data and the proportion adopted thereby, a continuous sequence 01 01 01 02 02 02 03 04 containing three 01, three 02, one 03, and one 04 is generated. The total length is the sum of the proportions adopted thereby. A random number generator is used to generate a number value 5318659. This number is used in a MOD 8 operation to obtain 3, which corresponds to the sequence value 02. Therefore, the selected encryption module database index is 02. Next, the flow goes to step S309. In step S309, according to the encryption module database index value 02, the encryption algorithm modules available thereto are retrieved from the encryption module database data (as shown in FIG. 14c), which are, respectively, a DES encryption algorithm indicator of the data encryption algorithm indicator, a SHA1 authentication algorithm indicator of the data authentication algorithm, and an MD5 authentication algorithm indicator of the integrated authentication algorithm indicator. Then, the flow goes to step S310. In step S310, as the data encryption algorithm indicator, which is the DES encryption algorithm indicator, is not 0, the flow goes to step S311. In step S311, the DES encryption algorithm index and the data field data of the inputted data (as shown in FIG. 14a) are sent to the encryption portion for encryption processing. Then, the flow goes to step S312. In step S312, as the data authentication algorithm indicator, which is the SHA1 authentication algorithm indicator, is not 0, the flow goes to step 8313. In step S313, the SHA1 authentication algorithm indicator and the result of encryption processing obtained in step S311 are sent to the authentication portion for data authentication processing. Next, the flow goes to step S314. In step S314, as the integrated authentication algorithm indicator, which is the MD5 authentication algorithm indicator, is not 0, the flow goes to step S315. In step S315, the MD5 authentication algorithm indicator, the header field data of the inputted data (as shown in FIG. 14a), and the result of data authentication processing obtained in step S313 are sent to the authentication portion for integrated authentication processing. The flow then goes to step S316. In step S316, a decryption information label and a decryption module database index value 02 are added to the processing result obtained in step S315 for output as outputted data (as shown in FIG. 14d) to the other devices. In FIG. 14, 14d denotes the outputted data obtained at the end of the flow of the encryption operation in this example, wherein the decryption information data includes the decryption information label and the decryption module database index value of 2.

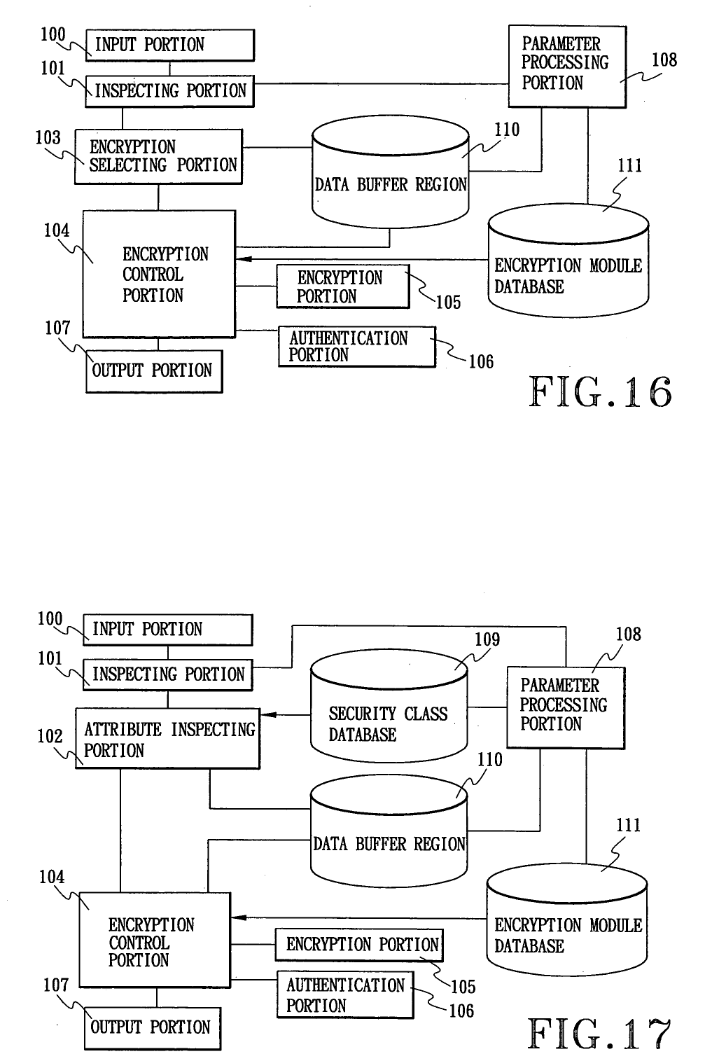

FIG. 16 is the block diagram illustrating another embodiment of the data encryption apparatus according to the present invention. As shown in FIG. 16, the security class database 109 and the attribute inspecting portion 102 of the example shown in FIG. 1 are not required. 108 denotes a parameter processing portion for inspecting the parameter data inputted from the inspecting portion. If the parameter flag field is an encryption algorithm module parameter flag, according to the encryption algorithm module identification code in the data field thereof, the encryption algorithm module parameter is stored in the data buffer region 110 at a parameter data storage address to which the encryption algorithm module corresponds. The encryption selecting portion 103 directly uses the encryption definition data stored in the data buffer region to dynamically select the encryption algorithm module combinations.

FIG. 17 is a block diagram illustrating still another embodiment of the encryption apparatus according to the present invention. As shown in FIG. 17, the encryption selecting portion 103 of the example shown in FIG. 1 is not required. The encryption definition data of the security class database 109 stores the data of only one encryption algorithm module combination. In addition, the attribute inspecting portion 102 directly sends the encryption algorithm module combination data stored in the encryption definition data to which attribute description data that matches the inputted data corresponds, together with the inputted data, to the encryption processing portion 104 for processing.

FIG. 2 is a block diagram of the preferred embodiment of a data decryption apparatus according to the present invention.

In FIG. 2, 208 denotes a decryption module database for storing relevant data of various combinations of decryption algorithms, authentication algorithms and integrated authentication algorithms used in performing decryption of inputted data. FIG. 11 is a schematic view illustrating the structure of the decryption module database. Each combination is represented by one record. Each entry of record includes a data decryption algorithm indicator, a data authentication algorithm indicator and an integrated authentication algorithm indicator. Each indicator, i.e., the address of the algorithm program, is formed by 4 bytes. The contents of the data decryption algorithm indicator can be:

DES decryption algorithm indicator, or

3DES decryption algorithm indicator, or

RSA decryption algorithm indicator, or

RC4 decryption algorithm indicator, or

FEAL decryption algorithm indicator, or

IDEA decryption algorithm indicator, or

TWOFISH decryption algorithm indicator.

The contents of the data authentication algorithm indicator and the integrated authentication algorithm indicator can be:

MD5 authentication algorithm indicator, or

SHA1 authentication algorithm indicator, or

N-HASH authentication algorithm indicator.

This preferred embodiment is exemplified using seven decryption algorithms and three authentication algorithms, and takes into account situations that do not require decryption or authentication. The decryption module database can store at most (7+1)*(3+1)*(3+1)=128 entries of records. 207 denotes a data buffer region for temporary storage of decryption authentication-related data stored by a parameter processing portion, and temporarily stored data required by a data inspecting portion and a decryption and authentication control portion during the course of processing.

200 denotes an input portion that is formed from a keyboard or any device that permits input of data packets.

201 denotes an inspecting portion which inspects inputted data and, if the data is parameter data, sends the same to the parameter processing portion, or otherwise inspects whether there is a decryption information label and, if there is none, sends an error code, or otherwise separates the inputted data into a decryption module database index and ciphertext for transmission to a decryption processing portion for processing.

202 denotes a decryption control portion which, according to the decryption module database index, retrieves a data decryption algorithm indicator, a data authentication algorithm indicator and an integrated authentication algorithm indicator, and performs decryption processing of the inputted data according to the algorithm module indicated by each of the indicators.

203 denotes an authentication portion which, according to the authentication algorithm indicator and the relevant data required thereby, performs authentication of the inputted data and sends the result to the decryption control portion.

204 denotes a decryption portion which, according to the decryption algorithm indicator and the relevant data required thereby, performs decryption processing of the inputted data and sends the result to the decryption control portion.

205 denotes an output portion for outputting decrypted data to a memory device or any other output device.

206 denotes the parameter processing portion which inspects the parameter data inputted by the inspecting portion and, if encryption algorithm module data is detected, updates the encryption algorithm module database or otherwise transmits an error code.

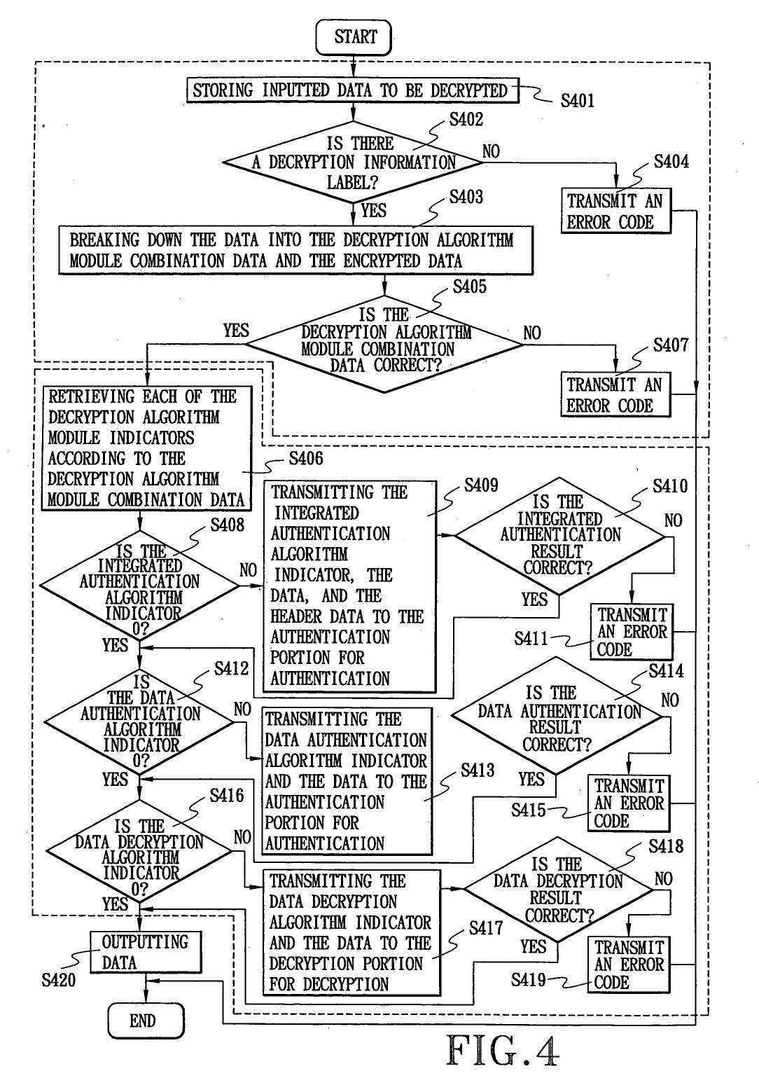

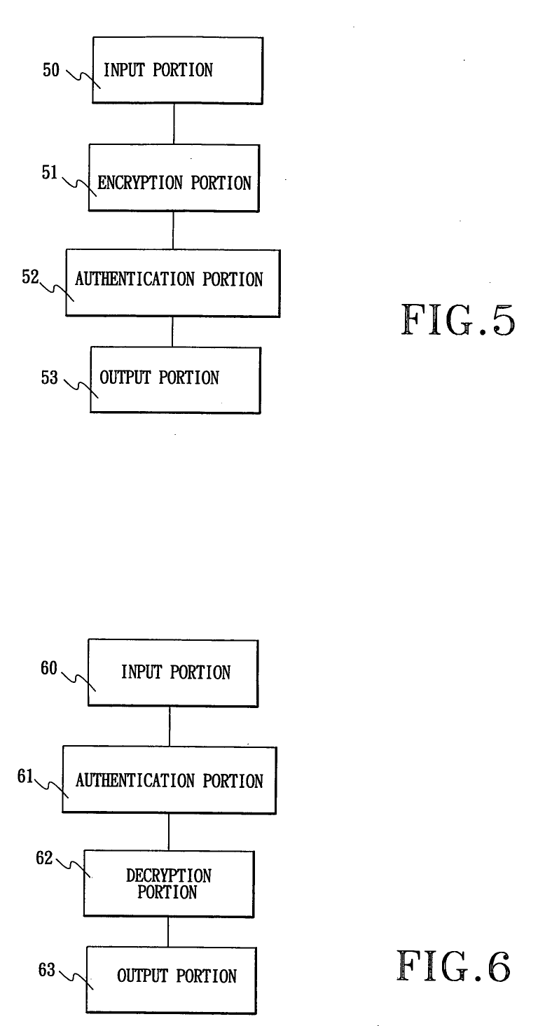

FIG. 4 is a flowchart of the data decryption operation in the preferred embodiment of the data decryption apparatus according to the present invention. In the block diagram of FIG. 2, when the inspecting portion 201 determines that the inputted data is data to be decrypted, input of the data is accepted in step S401. In step S402, it is determined whether the inputted data contains a decryption information label. If no, it is determined that the inputted data contains errors, and an error code is subsequently transmitted in step S404 to end the flow. Otherwise, step S403 is performed to break down the inputted data into decryption algorithm module combination data and ciphertext. Then, in step S405, it is determined whether the decryption algorithm module combination data is correct. If no, step S407 is performed to transmit an error code to end the flow. Otherwise, the flow goes to step S406. In step S406, the flow goes to the decryption control portion 202 which starts data decryption processing. Firstly, each of the decryption algorithm module indicators is retrieved according to the decryption algorithm module combination data. Then, in step S408, it is determined whether the integrated authentication algorithm indicator is 0. If it is 0, this indicates that integrated authentication processing is not to be executed, and the flow goes to step S412. Otherwise, the flow goes to step S409, in which the integrated authentication indicator and the parameter required thereby, together with the ciphertext and the header data, are processed and authenticated by the authentication portion 204 to obtain an authentication result. Then, the flow goes to step S410 to determine whether the authentication result is correct. If no, the flow goes to step S411 to transmit an error code before ending. Otherwise, the flow goes to step S412. In step S412, it is determined whether the data authentication algorithm indicator is 0. If it is 0, this indicates that data authentication processing is not to be executed, and the flow goes to step S416. Otherwise, the flow goes to step S413, in which the data authentication indicator and the parameter required thereby, together with the ciphertext, are authenticated by the authentication portion 204 to obtain an authentication result. Thereafter, the flow goes to step S414 to determine whether the authentication result is correct. If no, the flow goes to step S415 to transmit an error code before ending. Otherwise, the flow goes to step S416. In step S416, it is determined whether the data decryption algorithm indicator is 0. If it is 0, this indicates that data decryption processing is not to be executed, and the flow goes to step S420. Otherwise, the flow goes to step S417, in which the data decryption indicator and the parameter required thereby, together with the ciphertext, are processed by the decryption portion 204 to obtain a decrypted result. Then, the flow goes to step S418 to determine whether the decrypted result is correct. If no, the flow goes to step S419 to transmit an error code before ending. Otherwise, the flow goes to step S420, in which the decrypted data is outputted to a memory device or any other device.

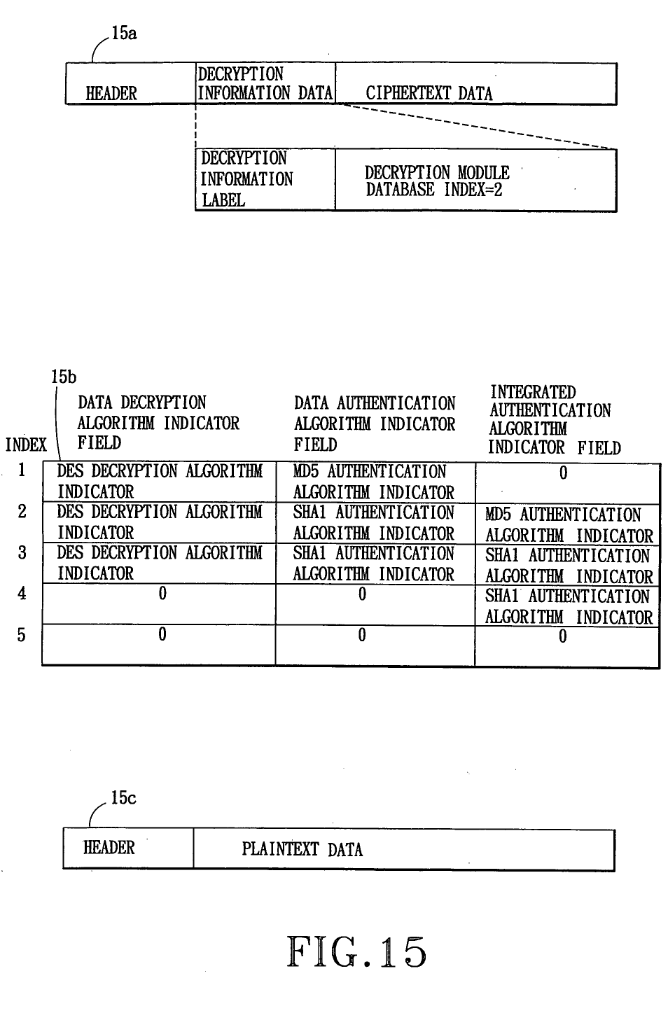

Hereinafter is a description of an example of processing in the preferred embodiment of the data decryption apparatus according to the present invention. FIG. 15 illustrates the data to be processed in the example in the preferred embodiment of the data decryption apparatus according to the present invention. In FIG. 15, 15a denotes the inputted data at the onset of the decryption operation flow according to the processing example, which includes a decryption information label and a decryption module database index value, which is 2, and ciphertext. 15b denotes the data of the decryption module database at the onset of the decryption operation flow in the processing example. 15c denotes outputted data at the end of the decryption operation flow in the processing example. In the data decryption operational flowchart of the preferred embodiment of the data decryption apparatus according to the present invention as illustrated in FIG. 4, after acceptance of the inputted data (as shown in FIG. 15a) in step S401, and after it has been determined in step S402 that the inputted data contains a decryption information label, step S403 is performed to break down the inputted data (as shown in FIG. 15a) into the decryption module database index value, which is 2, and the ciphertext, such as those shown in FIG. 15a. When it is determined in step S405 that the decryption module database index value of 2 is correct data, the flow goes directly to step S406. In step S406, according to the decryption module database index value 2, the decryption algorithm modules available thereto are retrieved from the decryption module database data (as shown in FIG. 15b), which are, respectively, a DES decryption algorithm indicator of the data decryption algorithm indicator, a SHA1 authentication algorithm indicator of the data authentication algorithm indicator, and an MD5 authentication algorithm indicator of the integrated authentication algorithm indicator. Then, the flow goes to step S408. In step S408, as the integrated authentication algorithm indicator, which is the MD5 authentication algorithm indicator, is not 0, the flow goes to step S409. In step S409, the MD5 authentication algorithm indicator, the header field data of the inputted data (as shown in FIG. 15a) and the ciphertext obtained in step S403, are sent to the authentication portion for integrated authentication processing. Next, the flow goes to step S410. In step S410, it is determined that the integrated authentication result is correct. Subsequently, the flow goes to step S412. In step S412, as the data authentication algorithm indicator, which is the SHA1 authentication algorithm indicator, is not 0, the flow goes to step S413. In step S413, the SHA1 authentication algorithm indicator and the ciphertext obtained in step S403 are sent to the authentication portion for data authentication processing. The flow then goes to step S414. In step S414, it is determined that the data authentication result is correct, and the flow goes to step S416. In step S416, as the data encryption algorithm indicator, which is the DES decryption algorithm indicator, is not 0, the flow goes to step S417. In step S417, the DES decryption algorithm indicator and the ciphertext obtained in step S403 are sent to the decryption portion for decryption processing. Then, the flow goes to step S418. In step S418, it is determined that the data encryption result is correct, and the flow goes to step S420. In step S420, according to the inputted data (as shown in FIG. 15a) and the decryption result obtained in step S418, output of the data (as shown in FIG. 15c) to other devices is completed.

The present invention is not limited to the preferred embodiments described hereinabove. For instance, the inputted data that is to be processed is not limited to packet data, and can be non-packet type digital data. In addition, the encryption definition data of the security class database according to the present invention, aside from storing encryption module database indexes and the corresponding proportions adopted thereby, can also store encryption algorithm indicators, data authentication algorithm indicators, integrated authentication algorithm indicators and the proportions adopted thereby, without the need to separately store the encryption algorithm module combination data in the encryption module database. Furthermore, while the preferred embodiments of the present invention have been described using packet data processing as examples, the present invention can also be applied to other forms of data.

In view of the foregoing, the encryption apparatus according to the present invention is able to overcome the problems associated with the prior art. In other words, the present invention has the effect that the encryption algorithm module combinations can switch automatically according to different attributes of the data. For example, when the user reads a message from a remote end terminal, the transmitted data is subjected to encryption processing using the safest encryption algorithm module combination during the course of authentication, while the other transmitted data adopt different encryption algorithm module combinations. Hence, the log-in account and password of the user will not be exposed. Besides, as the other transmitted data are subjected to encryption processing using different encryption algorithm module combinations, it is difficult for illegitimate users to read the contents of the data. At the same time, the transmission time can be improved by adjusting the proportion of use of the encryption algorithm module combinations.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

The present disclosure relates to subject matter contained in Chinese Patent Application No. 02152606.0, filed on Nov. 26, 2002, the contents of which is herein expressly incorporated by reference in its entirety.

What is claimed is:

1. A data encryption method, the method including the following steps:
Step A: constructing a security class database for storing a plurality of entries of records of data, each of the entries of records including a data attribute description field and a corresponding encryption definition field, the encryption definition field including a plurality of encryption algorithm module indicators;
Step B: inputting digital data to be encrypted;
Step C: from the security class database, finding a data attribute description that matches attribute of the digital data, and retrieving the corresponding encryption definition data;
Step D: from the retrieved encryption definition data, selecting at random an encryption algorithm module indicator;
Step E: with the selected encryption algorithm module indicator as a guide, controlling encryption processing of the inputted digital data; and
Step F: appending decryption information to the digital data that has undergone encryption processing for subsequent output.

2. The method as claimed in claim 1, wherein the encryption definition field in the security class database constructed in step A includes a plurality of encryption algorithm module indicators and corresponding proportions adopted thereby, an encryption algorithm module indicator being selected from the retrieved encryption definition data in step D according to each of the encryption algorithm module indicators and the corresponding proportions adopted thereby in cooperation with a random number generator and a MOD operation.

3. The method as claimed in claim 1, wherein the encryption definition field in the security class database constructed in step A includes a plurality of encryption algorithm module combinations, each of the encryption algorithm module combinations containing an encryption algorithm module indicator and an authentication algorithm module indicator, an encryption algorithm module combination being retrieved at random from the retrieved encryption definition data in step D, the selected encryption algorithm module combination being used as a guide for controlling encryption processing, including the type of encryption and the type of authentication, of the inputted digital data in step E.

4. The method as claimed in claim 3, wherein the encryption definition field in the security class database constructed in step A includes a plurality of encryption algorithm module combinations and corresponding proportions adopted thereby, an encryption algorithm module combination being selected from the retrieved encryption definition data in step D according to each of the encryption algorithm module combinations and the corresponding proportions adopted thereby in cooperation with a random number generator and a MOD operation.

5. A data encryption method, the method comprising the following steps:
Step A: constructing an encryption module database for storing a plurality of entries of records of data, each of the entries of records containing an encryption algorithm module indicator and an authentication algorithm module indicator;
Step B: constructing a security class database for storing a plurality of entries of records of data, each of the entries of records containing a data attribute description field and a corresponding encryption definition field, the encryption definition field including a plurality of encryption module database indexes;
Step C: inputting digital data to be encrypted;
Step D: from the security class database, finding a data attribute description that matches attribute of the digital data, and retrieving the corresponding encryption definition data;
Step E: from the retrieved encryption definition data, selecting at random an encryption module database index;
Step F: according to the retrieved encryption module database index, selecting an entry of record from the encryption module database;
Step G: with the selected entry of record as a guide, controlling encryption processing, including the type of encryption and the type of authentication, of the inputted digital data; and
Step H: appending decryption information to the digital data that has undergone encryption processing for subsequent output.

6. The method as claimed in claim 5, wherein the encryption definition field in the security class database constructed in step B includes a plurality of encryption module database indexes and corresponding proportions adopted thereby, an encryption module database index being selected from the retrieved encryption definition data in step E according to each of the encryption module database indexes and the corresponding proportions adopted thereby in cooperation with a random number generator and a MOD operation.

7. A data encryption method, the method comprising the following steps:
Step A: constructing encryption definition data containing a plurality of encryption algorithm module indicators;
Step B: inputting digital data to be encrypted;
Step C: from the encryption definition data, selecting at random an encryption algorithm module indicator;
Step D: with the selected encryption algorithm module indicator as a guide, controlling encryption processing of the inputted digital data; and
Step E: appending decryption information to the digital data that has undergone encryption processing for subsequent output.

8. The method as claimed in claim 7, wherein the encryption definition data constructed in step A includes a plurality of encryption algorithm module indicators and corresponding proportions adopted thereby, an encryption algorithm module indicator being selected from the encryption definition data in step C according to each of the encryption algorithm module indicators and the corresponding proportions adopted thereby in cooperation with a random number generator and a MOD operation.

9. The method as claimed in claim 7, wherein the encryption definition data constructed in step A includes a plurality of encryption algorithm module combinations, each of the encryption algorithm module combinations including an encryption algorithm module indicator and an authentication algorithm module indicator, an encryption algorithm module combination being selected at random from the retrieved encryption definition data in step C, the selected encryption algorithm module combination being used as a guide for controlling encryption processing, including the type of encryption and the type of authentication, of the inputted digital data in step D.

10. The method as claimed in claim 9, wherein the encryption definition data constructed in step A includes a plurality of encryption algorithm module combinations and corresponding proportions adopted thereby, an encryption algorithm module combination being selected from the retrieved encryption definition data in step C according to each of the encryption algorithm module combinations and the corresponding proportions adopted thereby in cooperation with a random number generator and a MOD operation.

11. A data encryption method, the method comprising the following steps:
Step A: constructing an encryption module database for storing a plurality of entries of records of data, each of the entries of records containing an encryption algorithm module indicator and an authentication algorithm module indicator;
Step B: constructing encryption definition data which includes a plurality of encryption module database indexes;
Step C: inputting digital data to be encrypted;
Step D: from the encryption definition data, selecting at random an encryption module database index;
Step E: according to the retrieved encryption module database index, selecting an entry of record from the encryption module database;
Step F: with the selected entry of record as a guide, controlling encryption processing, including the type of encryption and the type of authentication, of the inputted digital data; and
Step G: appending decryption information to the digital data that has undergone encryption for subsequent output.

12. The method as claimed in claim 11, wherein the encryption definition data constructed in step B includes a plurality of encryption module database indexes and corresponding proportions adopted thereby, an encryption module database index being selected from the encryption definition data in step D according to each of the encryption module database indexes and the corresponding proportions adopted thereby in cooperation with a random number generator and a MOD operation.

13. A data encryption method, the method comprising the following steps:
Step A: constructing a security class database for storing a plurality of entries of records of data, each of the entries of records containing a data attribute description field and a corresponding encryption definition field, the encryption definition data field being an encryption algorithm module indicator;
Step B: inputting digital data to be encrypted;
Step C: from the security class database, finding a data attribute description that matches attribute of the digital data, and retrieving the encryption algorithm module indicator of the corresponding encryption definition field;
Step D: with the selected encryption algorithm module indicator as a guide, controlling encryption processing of the inputted digital data; and
Step E: appending decryption information to the digital data that has undergone encryption processing for subsequent output.

14. The method as claimed in claim 13, wherein the encryption definition field in the security class database constructed in step A is an encryption algorithm module combination, the encryption algorithm module combination including an encryption algorithm module indicator and an authentication algorithm module indicator, data of an encryption algorithm module combination of the corresponding encryption definition field being retrieved in the step C of finding from the security class database the data attribute description that matches the attribute of the digital data, the selected encryption algorithm module combination being used in step D as a guide for controlling encryption processing, including the type of encryption and the type of authentication, of the inputted digital data.

15. A data encryption method, the method including the following steps:
Step A: constructing an encryption module database for storing a plurality of entries of records of data, each of the entries of records containing an encryption algorithm module indicator and an authentication algorithm module indicator;
Step B: constructing a security class database for storing a plurality of entries of records of data, each of the entries of records containing a data attribute description field and a corresponding encryption definition field, the encryption definition data field being an encryption module database index;
Step C: inputting digital data to be encrypted;
Step D: from the security class database, finding a data attribute description that matches attribute of the digital data, and retrieving the encryption module database index from the corresponding encryption definition field;
Step E: with the retrieved encryption module database index as a guide, selecting an entry of record from the encryption module database;
Step F: with the selected entry of record as a guide, controlling encryption processing, including the type of encryption and the type of authentication, of the inputted digital data; and
Step G: appending decryption information to the digital data that has undergone encryption processing for subsequent output.

16. A data encryption apparatus, the apparatus having an input portion for input of data and an output portion for output of data after encryption processing thereof, the apparatus further comprising:
a security class database for storing a plurality of entries of records of data, each of the entries of records containing a data attribute description field and a corresponding encryption definition field, the encryption definition field including a plurality of encryption algorithm module indicators;
an inspecting portion for inspecting and separating the data inputted via the input portion into parameter data or digital data;
a parameter processing portion for updating the security class database with the parameter data sent from the inspecting portion;
an attribute inspecting portion for finding from the security class database a data attribute description that matches attribute of the digital data sent from the inspecting portion and for transmitting the corresponding encryption definition data to a encryption selecting portion;
the encryption selecting portion, which selects at random an encryption algorithm module indicator from the retrieved encryption definition data; and an encryption processing portion for controlling encryption processing of the inputted digital data using the encryption algorithm module indicator selected by the encryption selecting portion as a guide.

17. The apparatus as claimed in claim 16, wherein the encryption definition field in the security class database includes a plurality of encryption algorithm module indicators and corresponding proportions adopted thereby, the encryption selecting portion selecting an encryption algorithm module indicator from the retrieved encryption definition data according to each of the encryption algorithm module indicators and the corresponding proportions adopted thereby in cooperation with a random number generator and a MOD operation.

18. The apparatus as claimed in claim 16, wherein the encryption definition field in the security class database includes a plurality of encryption algorithm module combinations, each of the encryption algorithm module combinations including an encryption algorithm module indicator and an authentication algorithm module indicator, the encryption selecting portion selecting at random an encryption algorithm module combination from the retrieved encryption definition data, the encryption processing portion, using the encryption algorithm module combination selected by the encryption selecting portion as a guide, controlling encryption processing, including the type of encryption and the type of authentication, of the inputted digital data.

19. The apparatus as claimed in claim 18, wherein the encryption definition field in the security class database includes a plurality of encryption algorithm module combinations and corresponding proportions adopted thereby, the encryption selecting portion selecting an encryption algorithm module combination from the retrieved encryption definition data according to each of the encryption algorithm module combinations and the corresponding proportions adopted thereby in cooperation with a random number generator and a MOD operation.

20. The apparatus as claimed in claim 16, further comprising:
an encryption module database for storing a plurality of entries of records of data, each of the entries of records containing an encryption algorithm module indicator and an authentication algorithm module indicator;
the encryption definition field of the security class database including a plurality of encryption module database indexes;
the encryption selecting portion selecting at random an encryption module database index from the retrieved encryption definition data and, according to the retrieved encryption module database index, and selecting an entry of record from the encryption module database;
the encryption processing portion using the entry of record selected by the encryption selecting portion as a guide to control encryption processing, including the type of encryption and the type of authentication, of the inputted digital data.

21. The apparatus as claimed in claim 20, wherein the encryption definition field in the security class database includes a plurality of encryption module database indexes and corresponding proportions adopted thereby, the encryption selecting portion selecting an encryption module database index from the retrieved encryption definition data according to each of the encryption module database indexes and the corresponding proportions adopted thereby in cooperation with a random number generator and a MOD operation, and selecting an entry of record from the encryption module database according to the retrieved encryption module database index.

22. The apparatus as claimed in claim 20, wherein the parameter processing portion updates the security class database and the encryption module database using the parameter data sent from the inspecting portion.

23. A data encryption apparatus, the apparatus having an input portion for input of data and an output portion for output of data after encryption processing thereof, the apparatus further comprising:
a encryption module database for storing a plurality of entries of records of data, each of the entries of records containing an encryption algorithm module indicator;
an inspecting portion for inspecting and separating the data inputted via the input portion into parameter data or digital data;
a parameter processing portion for updating the encryption module database using the parameter data from the inspecting portion;
a encryption selecting portion for selecting at random an entry of record from the encryption module database; and
an encryption processing portion for controlling encryption processing of the inputted digital data using the entry of record selected by the encryption selecting portion as a guide.

24. The apparatus as claimed in claim 23, wherein the encryption module database stores a plurality of entries of records of data, each of the entries of records containing an encryption algorithm module indicator and a corresponding proportion adopted thereby, the encryption selecting portion selecting an entry of record according to the corresponding proportion adopted by each of the entries of records in the encryption module database in cooperation with a random number generator and a MOD operation.

25. The apparatus as claimed in claim 23, wherein the encryption module database stores a plurality of entries of records of data, each of the entries of records containing an encryption algorithm module indicator and an authentication algorithm module indicator, the encryption processing portion controlling encryption processing, including the type of encryption and the type of authentication, using an encryption algorithm module combination of the entry of record selected at random by the encryption selecting portion as a guide.

26. The apparatus as claimed in claim 25, wherein the encryption module database stores a plurality of entries of records of data, each of the entries of records containing an encryption algorithm module indicator, an authentication algorithm module indicator and corresponding proportions adopted thereby, the encryption selecting portion selecting an entry of record from the encryption module database according to the corresponding proportion adopted by each entry of record in the encryption module database in cooperation with a random number generator and a MOD operation.

27. A data encryption apparatus, the apparatus having an input portion for input of data and an output portion for output of data after encryption processing thereof, the apparatus further comprising:
a security class database for storing a plurality of entries of records of data, each of the entries of records containing a data attribute description field and a corresponding encryption definition field, the encryption definition field being an encryption algorithm module indicator;
an inspecting portion for inspecting and separating the data inputted via the input portion into parameter data or digital data;
a parameter processing portion for updating the security class database with the parameter data from the inspecting portion;
an attribute inspecting portion for finding from the security class database a data attribute description that matches attribute of the digital data sent from the inspecting portion and for transmitting the corresponding encryption definition data to an encryption processing portion; and
the encryption processing portion for controlling encryption processing of the inputted digital data using the encryption algorithm module indicator selected by the attribute inspecting portion as a guide.

28. The apparatus as claimed in claim 27, wherein the encryption definition field in the security class database is an encryption algorithm module combination, the encryption algorithm module combination including an encryption algorithm module indicator and an authentication algorithm module indicator, the encryption processing portion, using the encryption algorithm module combination selected by the parameter inspecting portion as a guide, controlling encryption processing, including the type of encryption and the type of authentication, of the inputted digital data.

29. A data decryption method, the method comprising the following steps:
Step A: inputting digital data to be decrypted;
Step B: inspecting whether the digital data includes a decryption algorithm module indicator and, in the affirmative, retrieving the decryption algorithm module indicator or, in the negative, setting the data to be decrypted as equivalent to inputted data for subsequent processing in step D;
Step C: with the retrieved decryption algorithm module indicator as a guide, controlling decryption processing of the inputted digital data; and
Step D: outputting the digital data that has undergone decryption.

30. The method as claimed in claim 29, wherein, in step B, the digital data is inspected to determine whether the digital data includes a decryption algorithm module combination having a decryption algorithm module indicator and an authentication algorithm module indicator and, in the affirmative, the decryption algorithm module combination is retrieved or, in the negative, the data to be decrypted is set to be equivalent to inputted data for subsequent processing in step D; and in step C, decryption processing, including the type of decryption and the type of authentication, of the inputted digital data is controlled using the selected decryption algorithm module combination as a guide.

31. A data decryption method, the method comprising the following steps:
Step A: constructing a decryption module database for storing a plurality of entries of records of data, each of the entries of records being a decryption algorithm module indicator;
Step B: inputting digital data to be decrypted;
Step C: inspecting whether the digital data includes a decryption module database index and, in the affirmative, retrieving the decryption module database index or, in the negative, setting the data to be decrypted as equivalent to inputted data for subsequent processing in step F;
Step D: with the retrieved decryption module database index as a guide, selecting an entry of record from the decryption module database;
Step E: with the selected entry of record as a guide, controlling decryption processing of the inputted digital data; and
Step F: outputting the digital data that has undergone decryption.

32. The method as claimed in claim 31, wherein, in step A, a decryption module database for storing a plurality of entries of records of data is constructed, each of the entries of records containing a decryption algorithm module indicator and an authentication algorithm module indicator, and in step E, the selected entry of record is used as a guide for controlling decryption processing, including the type of decryption and the type of authentication, of the inputted digital data.

33. A data decryption apparatus, the apparatus having an input portion for input of data and an output portion for output of data after decryption processing thereof, the apparatus further comprising:
an inspecting portion for inspecting whether the data inputted via the input portion includes a decryption algorithm module indicator and, in the affirmative, retrieving the decryption algorithm module indicator or, in the negative, transmitting the inputted data directly to the output portion; and
a decryption processing portion for controlling decryption processing of the inputted digital data using the decryption algorithm module indicator retrieved by the inspecting portion as a guide.

34. The apparatus as claimed in claim 33, wherein the inspecting portion inspects whether the data inputted via the input port ion includes a decryption algorithm module combination, the decryption algorithm module combination including a decryption algorithm module indicator and an authentication algorithm module indicator, and, in the affirmative, retrieves the decryption algorithm module combination or, in the negative, transmitting directly the inputted data to the output portion, the decryption processing portion controlling the decryption processing, including the type of decryption and the type of authentication, of the inputted digital data using the decryption algorithm module indicator retrieved by the inspecting portion as a guide.

35. The apparatus as claimed in claim 33, further comprising: a decryption module database for storing a plurality of entries of records of data, each of the entries of records containing a decryption algorithm module indicator, the inspecting portion inspecting whether the data inputted via the input portion includes a decryption module database index and, in the affirmative, retrieving the decryption module database index and further retrieving an entry of record from the decryption module database using the index or, in the negative, transmitting directly the inputted data to the output portion, the decryption processing portion controlling the decryption processing of the inputted digital data using the entry of record retrieved by the inspecting portion as a guide.

36. The apparatus as claimed in claim 35, wherein the decryption module database stores a plurality of entries of records of data, each of the entries of records containing a decryption algorithm module indicator and an authentication algorithm module indicator, the decryption processing portion controlling decryption processing, including the type of decryption and the type of authentication, using the entry of record retrieved by the inspecting portion as a guide.

37. The apparatus as claimed in claim 35, further comprising: a parameter processing portion for updating the decryption module database using parameter data, the inspecting portion inspecting and separating the data inputted via the input portion into parameter data or digital data and, if the inputted data is parameter data, transmitting the same to the parameter processing portion and, if the inputted data is digital data, inspecting whether the digital data includes a decryption module database index and, in the affirmative, retrieving the decryption module database index and further retrieving an entry of record from the decryption module database using the index and, in the negative, transmitting directly the inputted data to the output portion.

38. The apparatus as claimed in claim 37, wherein the decryption module database stores a plurality of entries of records of data, each of the entries of records containing a decryption algorithm module indicator and an authentication algorithm module indicator, the decryption processing portion controlling decryption processing, including the type of decryption and the type of authentication, of the inputted digital data using the entry of record retrieved by the inspecting portion as a guide.

39. The apparatus as claimed in claim 21, wherein the parameter processing portion updates the security class database and the encryption module database using the parameter data sent from the inspecting portion.
